(19) United States
(12) Patent Application Publication
(10) Pub. No.: US 2016/0293004 A1
(43) Pub. Date: Oct. 6, 2016

(54) METHOD AND SYSTEM FOR CONTROLLING AND MONITORING TRAFFIC LIGHT FOR OPTIMIZING WAIT TIME

(71) Applicant: Umm Al-Qura University, MAKKAH (SA)

(72) Inventors: Khalid Al-Jawa'Deh, MAKKAH (SA); Kheir Eddine Bouazza, MAKKAH (SA)

(21) Appl. No.: 14/679,886

(22) Filed: Apr. 6, 2015

(51) Int. Cl. G08G 1/095; G08G 1/052; G08G 1/01

(52) U.S. Cl. CPC G08G 1/095; G08G 1/0145; G08G 1/052

(57) ABSTRACT

Today's infrastructures allow for a single signal per lane that works in a stop and go fashion. Every vehicle that requires access the shared resource traffic junction moves through the junction when it is given a green signal. If not, they wait in a line which is service First Come First Served (FCFS) manner. Intuitively, the probability of waiting is higher compared to moving in today's deployments. We propose an intelligent control system that adaptively streamlines the traffic using multiple traffic signals per lane. The traffic signals have the capability of alerting the vehicles on the speed to travel for smooth crossing of all signals to access the shared resource traffic junction. With vehicles moving continuously, the waiting time is minimized. In addition, the method reduces pollution and gas expense while maximizing the utilization of the shared resource traffic junction capacity.

### FIELD OF TECHNOLOGY

This disclosure relates generally to a field of a method and system for real time traffic controlling, monitoring and optimizing wait time.

### BACKGROUND

Infrastructure costs have increased year over year. With the advent of increase in the number of vehicles, road congestion has become a real problem. It is not economically feasible to increase the capacity of every road in a country to cater to the increase in number of vehicles.

The traffic pattern in the roads is not very uniform. The traffic is very high in certain period of time, such as morning office peak hour and evening home return peak hour. At the same time, the traffic is low during off peak hours. It does not make sense to engineer the number of lanes based on the high usage data as it could happen a fraction of time in a year. Therefore, it is important to manage the existing resource properly before spending on infrastructure increases. If there is an intelligent way to increase the throughput of the vehicle within the available infrastructure, then important infrastructure cost can be minimized and expansion delayed.

The amount of resources spent by static cars waiting for a signal is huge. It is well known that the gas spent by a vehicle during the start time is higher compared to when the vehicle is in steady state running. Therefore, in a busy signal of a four lane junction, if one lane is having green, then there are at least two other lanes that have waiting vehicles burning gas. When those two lanes get the signal, the gas spent is even higher as all the waiting vehicles move from neutral to first gear in which state maximum gas is spent in a vehicle. If there is a way to keep the vehicles at a higher gear by shaping the traffic earlier on, then the gas expense can be minimized.

The environmental effect of pollution due to busy intersections in a large city is quite severe. Typical busy intersections almost always have waiting vehicles in either of the directions waiting to cross the important shared resource traffic junction. If there is a way to keep the vehicles moving and maximizing the capacity of the shared resource junction, the pollution can be minimized.

Today's infrastructures allow for a single signal per lane that works in a stop and go fashion. Every vehicle that requires access the shared resource traffic junction moves through the junction when it is given a green signal. If not, they wait in a line which is service First Come First Served (FCFS) manner. In an equally likely scenario, the probability of having green is half in case the vehicle has to travel North-South or East-West. The probability is even less if it has to turn. Intuitively, the probability of waiting is higher compared to getting green in today's methodology. There is a need to streamline the traffic beforehand to create a smooth transition through the traffic junction using an intelligent method, the probability of waiting can be made smaller leading to less pollution, less gas expense and less wait time.

### SUMMARY

Several embodiments for a system and method for traffic controlling, monitoring, shaping and optimization of a junction are disclosed. More particularly, the system and method relates to an intelligent control system that periodically monitors multiple traffic signals and adaptively changes the wait time to optimize the throughput, utilization and capacity of the shared resource traffic junction. In one embodiment, the vehicles are in a traditional multilane traffic junction where vehicles experience Wait and Go states through Red, Amber and Green signals. The proposed methodology optimizes the capacity of the shared resource traffic junction.

In one embodiment, a two queue system showing two traffic signals per lane is shown to shape the traffic enabling fluidity. The two queue system per lane is implemented using traffic signals with Red, Amber and Green.

In one embodiment, a two stage system that has two queues per lane is introduced to optimize the throughput of the vehicles per lane. The two stage system implemented using two traffic signals direct the vehicles to wait or go forward providing a binary indication. The first traffic signal manages the vehicles and adjusts the queue before allowing the vehicles to move to the important second signal at the junction. This increases the chance of the vehicle crossing the first signal to move through the second signal seamlessly.

In one embodiment, a two stage system uses the distance between the two queues as a buffer space to slow or speed the vehicles to intelligently control the movement before crossing the shared resource traffic junction. The goal of the method is to keep the traffic fluid and moving so the stop and start of a vehicle can be minimized leading to pollution and gas minimization.

In one embodiment, an intelligent traffic shaping system is shown to manage the traffic by using methods such as hysteresis to predict the time and speed needed in a signal for adaptively optimizing the fluidity of vehicle traffic. The signals have Red, Amber and Green, with Amber clearly displaying the speed to be maintained by the vehicles crossing that signal optimizing the chance of clearing the shared resource traffic junction.

In one embodiment, a two stage system uses the intelligent traffic shaping system with Amber disclosing the optimal speed for vehicles to maintain so that the traffic moves smoothly across the lane to cross the junction.

In one embodiment, a multi stage system is shown to have multiple queues to manage vehicles coming through to cross a very busy intersection. Multi stage system manages vehicles in a busy and high speed junction so the traffic shaping can be done in a staged manner.

In one embodiment, a multi stage system uses multiple queues per lane implemented through traffic signals that provide binary Wait and Go indication for streamlining the traffic. Vehicles are staged far ahead of reaching the junction through multiple signals increasing the probability of crossing the junction seamlessly. The junction capacity is increased by ascertaining larger volume of traffic crossing the shared resource in a given time.

In one embodiment, a multi stage system uses multiple traffic signals that are adaptively managed by an intelligent control system to provide optimal speed to maintain. This speed is clearly displayed in Amber state so the traffic can move at the relayed speed for maximum chance of crossing the junction without stopping. The Green state is specified for the traffic to move at the maximum speed.

In one embodiment, an intelligent control system is proposed to manage multiple queues through traffic signals where the system uses past history, present data, distance between the signals, speed limits and the probability of acquiring the junction time to calculate the optimal speed for the vehicles to travel. The vehicles move from signal to signal thus moving mathematically from Wait state to Go state in every signal, with the junction being the final state. Similarly, the traffic signals also operate a tristate system with Red, Amber and Green being the three states of operation.

In one embodiment, the method is shown to work in left hand drive traffic rules, mostly followed in non-former British colony countries. In another embodiment, the method is shown to work in right hand drive traffic rules, followed by former British colony countries.

In one embodiment, the method is shown for four lane intersection, namely North, South, East and West. Without loss of generality, the solution is for multi-lanes without constraining to four lane intersections.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the Fig.s of the accompanying drawings, in which like references indicate similar elements and in which:

FIG. 1 is a systemic view of a traffic junction for vehicles that follow right hand drive.

FIG. 2 is a systemic view of a traffic junction for vehicles that follow left hand drive.

FIG. 3 illustrates the queuing architecture per signal in a traffic junction.

FIG. 4 illustrates the queuing architecture for a traffic junction that follow right hand drive.

FIG. 5 illustrates the queuing architecture for a traffic junction that follow left hand drive.

FIG. 6 illustrates the queuing architecture for a two stage system for a traffic junction that follow right hand drive. Two stage systems correspond to two signals per direction.

FIG. 7 illustrates the queuing architecture for a two stage system for a traffic junction that follow left hand drive. Two stage systems correspond to two signals per direction.

FIG. 8 depicts the queuing architecture for a multi stage system for a traffic junction that follows right hand drive. Multi stage systems correspond to multiple signals per direction.

FIG. 9 depicts the queuing architecture for a multi stage system for a traffic junction that follows left hand drive. Multi stage systems correspond to multiple signals per direction.

FIG. 10 shows the multistage traffic shaping system. The Fig. illustrates the deployment and implementation of the multi stage system methodology.

FIG. 11 shows the multi stage discrete binary traffic shaping system.

FIG. 12 illustrates multi stage adaptive traffic shaping system.

FIG. 13 illustrates the intelligent traffic shaping methodology for multi stage adaptive system.

FIG. 14 shows the traffic signal state transition diagram. There are three states—Stop, Alert and Go.

FIG. 15 illustrates the vehicle state transition diagram. The vehicle transits through multi stage traffic system to cross the traffic junction.

FIG. 16 is an example of two stage system where both traffic signals are Green in East direction, according to one embodiment.

FIG. 17 illustrates the two stage system where the signals are Red and Green in East and Red and Green in South, according to one embodiment.

FIG. 18 illustrates the two stage system where the signals are Red and Red in East and Green and Green in South, according to one embodiment.

FIG. 19 illustrates the two stage system where the signals are Green and Red in East and Red and Green in South, according to one embodiment.

FIG. 20 illustrates the two stage system where the signals are Green and Green in East and Red and Red in South, according to one embodiment.

FIG. 21 illustrates the performance characteristic of traffic utilization at the shared resource traffic junction.

Other features of the present embodiments will be apparent from the accompanying drawings and from the detailed description that follows.

### DETAILED DESCRIPTION

Several method and system for intelligent traffic shaping, policing, controlling, monitoring and management for traffic streamlining and response time and queue length optimization are disclosed. This disclosure also relates to a comprehensive methodology of calibrating periodically and adaptively various traffic signals that smoothens and shapes the flow of traffic to reduce the wait times at traffic lights. More particularly, it relates to an intelligence based control system that continuously over real-time observes the sensor results, analyze through hysteresis and draws conclusion using traffic patterns and to meaningfully control the traffic in a multilane junction. In the proposed methodology, we show how such an intelligent system can be created where the pollution, gas expense and wait time can be minimized while maximizing the shared resource traffic junction capacity.

Although the present embodiments have been described with reference to specific example embodiments, it will be evident that various modifications and changes may be made to these embodiments without departing from the broader spirit and scope of the various embodiments.

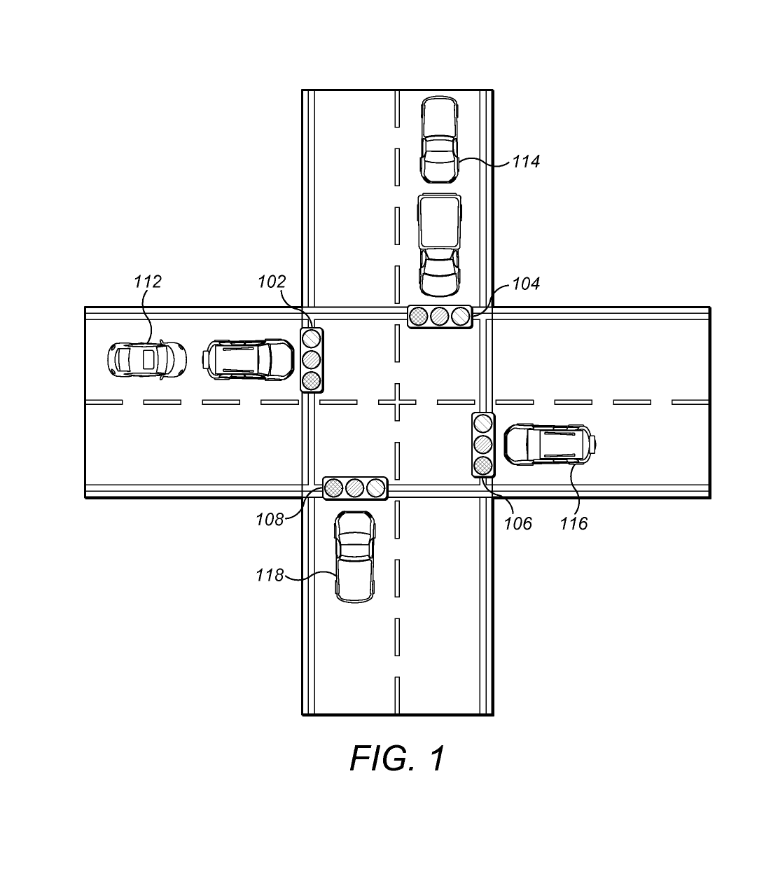

FIG. 1 is an illustration of a traffic junction for a right hand drive system. The Fig. shows a typical traffic junction, where without loss of generality, we can assume East, West, North and South as the four directions shown in the junction Fig. The junction consists of traffic signals—Signal in West 102 for traffic moving towards North, East and South. Similarly, traffic signal 104 depicts the traffic control in North side, traffic signal 106 depicts the traffic control in East side and the traffic signal 108 depicts the traffic control in the South side. The Fig. depicts a queue of cars waiting for signal in West side 112, North side 114, East side 116 and South side 118.

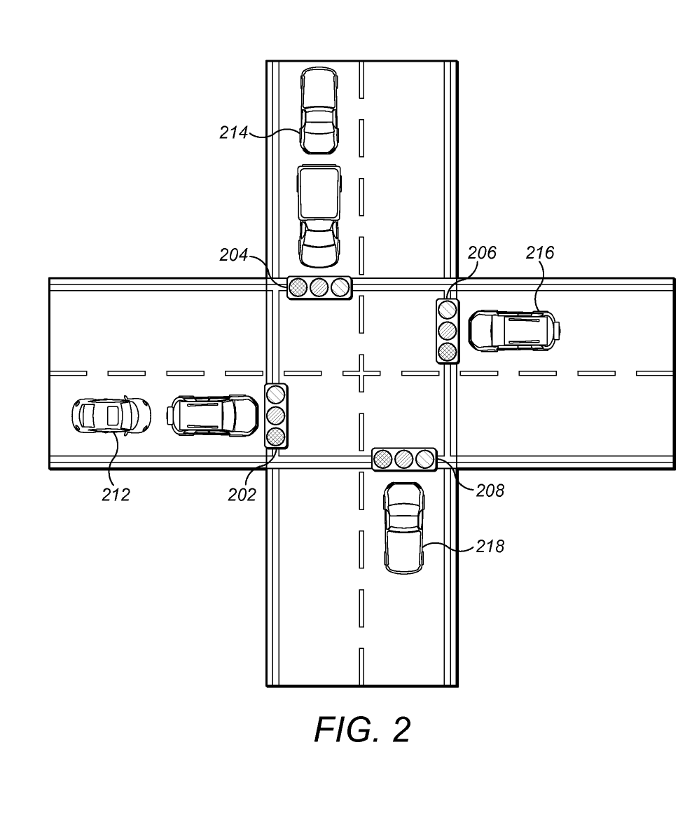

FIG. 2 illustrates a traffic junction for a left hand drive system. The Fig. shows a typical traffic junction, where without loss of generality, we can assume East, West, North and South as the four directions shown in the junction Fig. The junction consists of traffic signals—Signal in West 202 for traffic moving towards North, East and South. Similarly, traffic signal 204 depicts the traffic control in North side, traffic signal 206 depicts the traffic control in East side and the traffic signal 208 depicts the traffic control in the South side. The Fig. depicts a queue of cars waiting for signal in West side 212, North side 214, East side 216 and South side 218.

FIG. 1 and FIG. 2 illustrates the traffic junction that is common in all the countries in the world. Most British colonies use right hand driving and others use left hand driving. The proposed methodology to minimize the waiting time and maximize the throughput across is equally achieved in both the scenarios. The commonly followed traffic rules across the world is to have a traffic signal with three colors, namely Red for stop, Amber for alert, and Green of go. The decision is pretty much taken on whether to stop or go by the driver on approaching the junction without any warning prior to arrival. We provide an intelligent traffic shaping methodology that shapes the traffic towards achieving lower delay and higher throughput that is unique.

Present day traffic junction does not provide any clear indication on length of the queue or the total waiting time before signal is received. In addition, there is no control mechanism where the vehicles can be slowed down far ahead of time so they ease into the junction without stopping thus saving valuable time and increasing the throughput and utilization of the shared resource, in this case the junction.

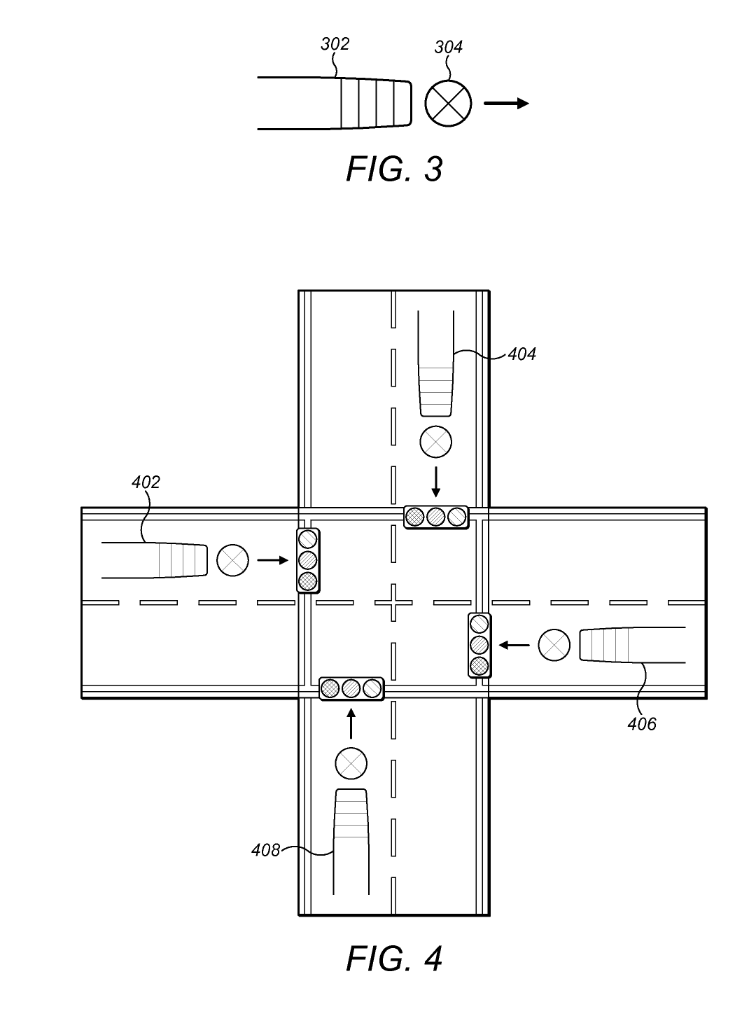

FIG. 3 illustrates the queuing architecture for a signal regardless of the direction of drive. In a single signal system per direction, the vehicles form a queue 302 and the processing is done by the traffic signally processing 304. The processing is a simple stop and go. If stopped (Red), the vehicles form a queue that is in general serviced First Come First Served (FCFS) and if not stopped (Green), then the vehicles continue to cross into the direction they wish to go.

FIG. 4 illustrates an exploded view of the queuing architecture per traffic junction for right hand drive scenario. As can be seen, the traffic from West direction form a queue based on the signal state 402. The vehicles in general scenario wait for the signal to turn Green before entering the junction and until then wait in queue. The central traffic junction is a shared resource that needs to be maximized. FIG. 4 depicts the traditional scenario where there are signals guarding each direction for access to the junction. Queues are formed in West 402, North 404, East 406 and South 408 to access the junction. The queues are serviced based on the signals turning green.

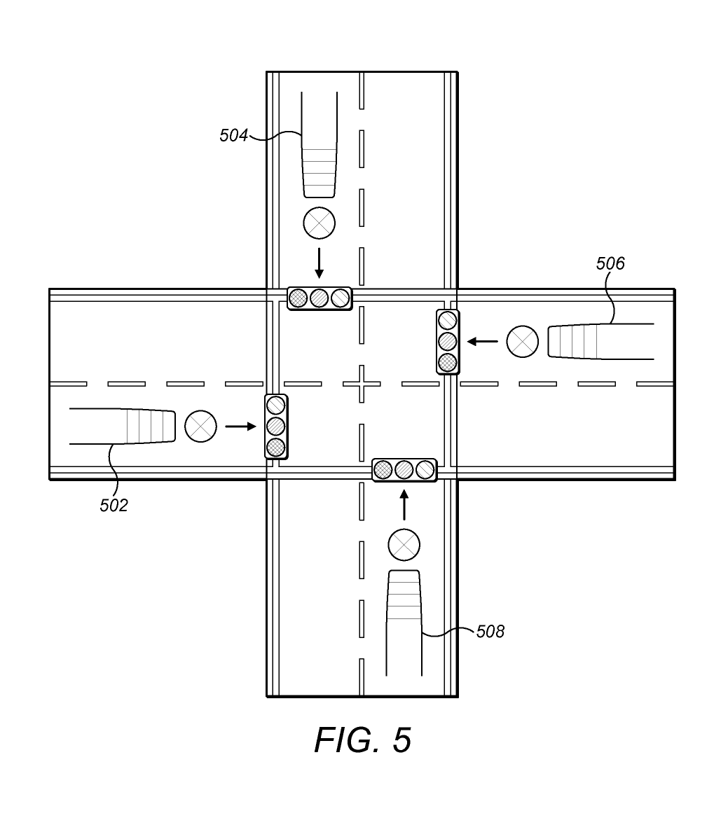

FIG. 5 illustrates an exploded view of the queueing architecture per traffic junction for left hand drive scenario. As can be seen, the traffic from West direction form a queue based on the signal state 502. The vehicles in general scenario wait for the signal to turn Green before entering the junction and until then wait in queue. The central traffic junction is a shared resource that needs to be maximized. FIG. 5 depicts the traditional scenario where there are signals guarding each direction for access to the junction. Queues are formed in West 502, North 504, East 506 and South 508 to access the junction. The queues are serviced based on the signals turning green.

FIGS. 4 and 5 illustrate the general architecture of the traffic system existing in the world today. In one embodiment, FIG. 4 shows the right hand drive scenario where most of the Britain and former British colonies adopt. In another embodiment, FIG. 5 shows the left hand drive scenario where most of the non-British colonies adopt for driving. The draw back in these two embodiments are the non-optimal usage of traffic junction, where vehicles move into the shared area when given Green signal need to start and slowly through. In this patent, we show an intelligent methodology that reduces the queue length and increases the throughput capacity right across the junction.

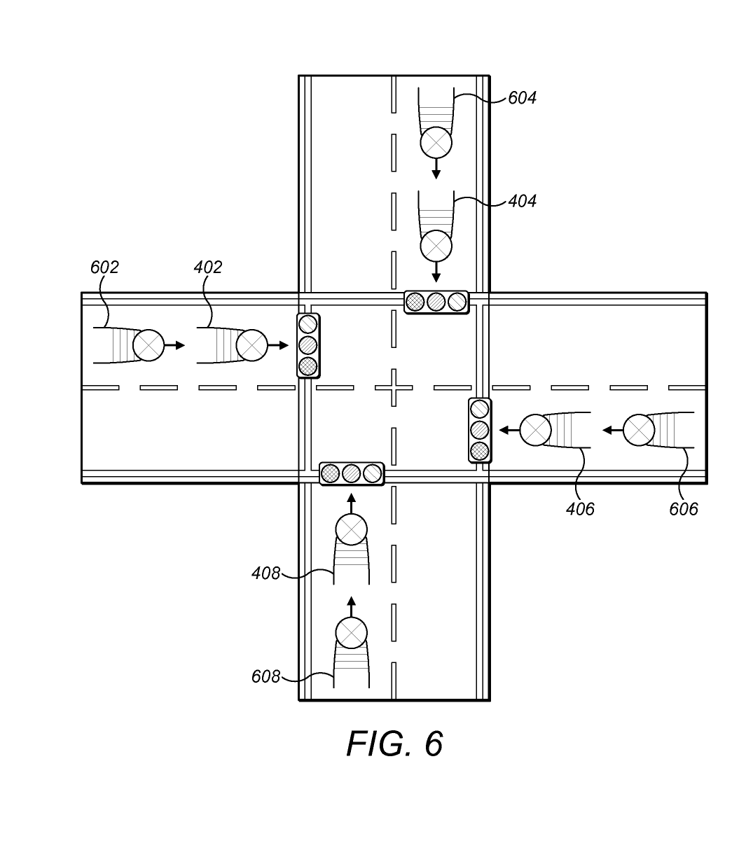

FIG. 6 illustrates an embodiment of a multi stage system for right hand drive for a two stage system. In a two stage system, there are two queues in each direction. For example, West contains two queues 402 and 602 both guided by a traffic signal. In this multistage embodiment, we can clearly see that the vehicles are traffic shaped using the initial signal 602 before they enter into the next signal 402 for smooth transition to access the shared resource, namely the traffic junction. Similarly, the traffic is shaped in the North by a second traffic signal, whose queue is represented by 604. The traffic is shaped in the East by a second traffic signal 606 and the South by 608.

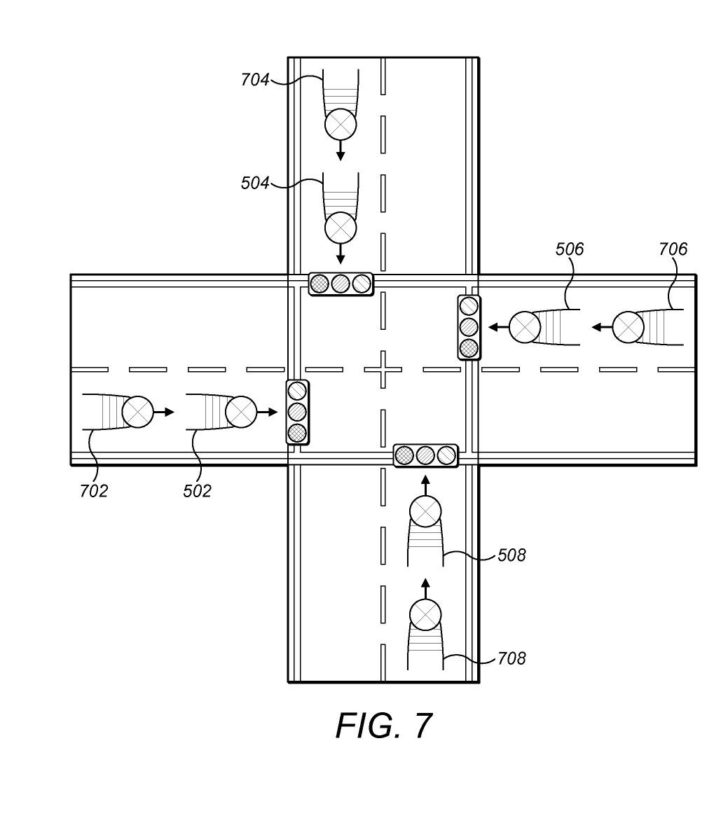

Similarly FIG. 7 illustrates an embodiment of a multi stage system for left hand drive for a two stage system. In a two stage system, there are two queues in each direction. For example, West contains two queues 502 and 702 both guided by a traffic signal. In this multistage embodiment, we can clearly see that the vehicles are traffic shaped using the initial signal 702 before they enter into the next signal 502 for smooth transition to access the shared resource, namely the traffic junction. Similarly, the traffic is shaped in the North by a second traffic signal, whose queue is represented by 704. The traffic is shaped in the East by a second traffic signal 706 and the South by 708.

FIGS. 6 and 7 illustrate the two stage system, an embodiment of the multistage system. Present traffic controls do not possess multiple queues that are proposed as part of this patent. The first signal provides an intelligent method of regulating the traffic while the second signal closer to the junction provides a smoother access to the shared resource thus enhancing the capacity of the junction.

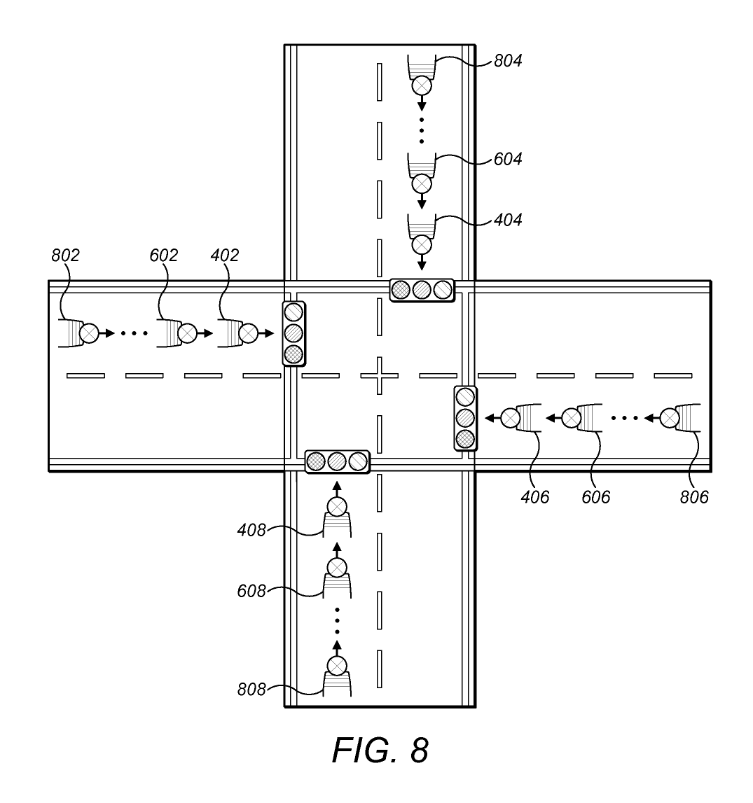

FIG. 8 illustrates the proposed methodology of supporting a multistage system for right hand drive scenario. A multistage system consists of regulating the traffic through various traffic signals to streamline the flow of traffic to access the shared resource, namely the traffic junction in a seamless and efficient manner. A multistage system prepares the traffic beforehand so the vehicles on the move are committed to cross the junction thus increasing the junction utilization and the throughput. Multistage queue is implemented in all the traffic directions. Without restricting the solution, FIG. 8 illustrates the traffic flowing in four directions. Traffic originating from the West has multiple queues with the first queue encountered by the fleet of vehicles 802 starts the shaping, followed by various other traffic signals to shape ending with 602 and 402. Similarly, the North traffic has the ingress queue 804 followed by multiple queues for shaping ending with 604 and 404. The traffic from West has an ingress queue of 806 followed by multiple queues ending with 606 and 406. Finally, in the illustration, we can see the ingress queue for South being 808 followed by multiple queues ending with 608 and 408. Every queue is regulated by a traffic signal which acts as a shaper. The methodology, explained later, intelligently controls the signal parameter to maintain the flow to maximize throughput and traffic junction capacity.

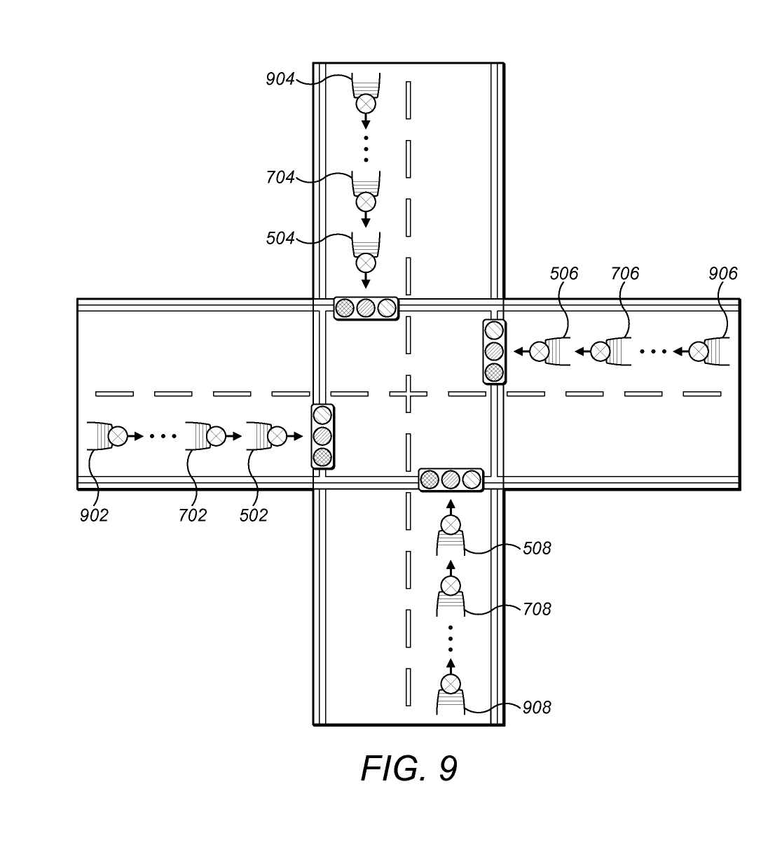

FIG. 9 in another embodiment describes the queueing architecture of the multistage system for left hand drive scenario. The embodiment illustrates four directional junctions, though in reality it can be for any number of directions. It can be noted that in West originated direction, the vehicles encounter the ingress queue 902 first to shape the traffic, before guided by multiple traffic lights culminating in 702 and 502. Similarly, the North originating traffic has an ingress queue of 904 followed by several shapers before culminating in 704 and 504. The Eastern originating traffic has ingress of 906 followed by 706 and 506. Finally the South originating traffic ingresses at 908 followed by several queues before finally reaching 708 and 508. In general multistage systems are used for major junctions where the speed is high and the shared resource is scarce. Therefore to manage such a scarce resource, namely the junction, for capacity is of paramount importance lest will lead to a longer queue length and delay.

FIGS. 8 and 9 together illustrate the embodiment of multistage system queuing architecture for left hand drive and right hand drive scenarios. Without loss of generality, the same architecture is applied for multi directional traffic junctions. The embodiment can have any type of vehicle.

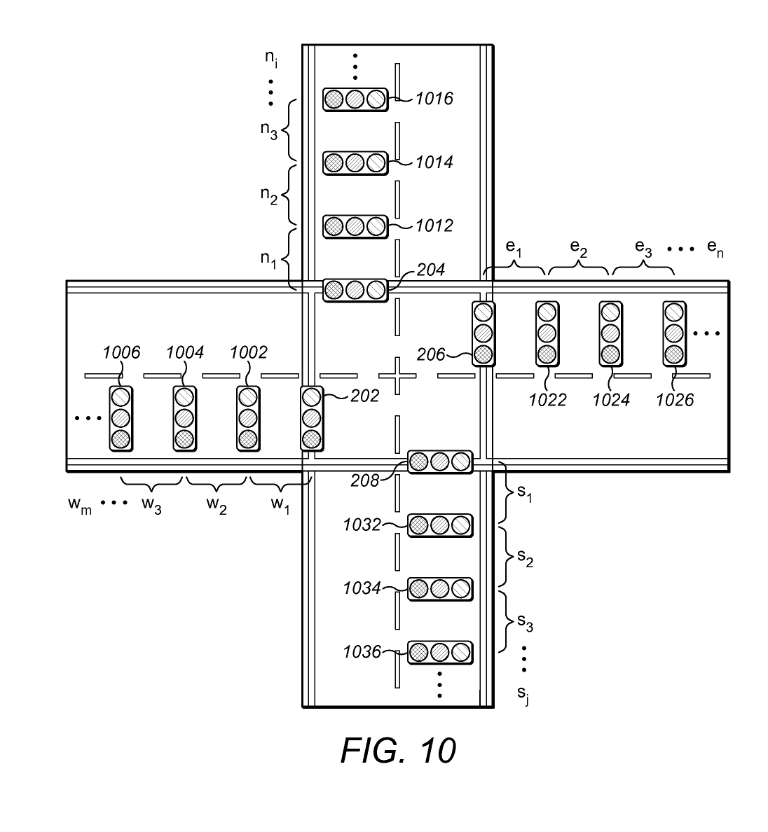

FIG. 10 illustrates the proposed multistage traffic shaping system. In one embodiment, the left hand drive scenario is depicted in the FIG. 10, where the traffic shaping using multistage queuing system is shown clearly through traffic signals. In another embodiment, the right hand drive scenario follows the dual of the presented scenario in FIG. 10. The number of signals depends on the traffic constraints. For example, a multiple lane traffic junction with a higher speed highway will have multiple traffic signals spaced at different distance from the previous traffic signal, that are managed adaptively through the proposed intelligent module. The goal of the proposal is to manage the junction traffic better leading to optimal throughput and smooth traffic flow. The West initiated traffic consists of multiple signals to incorporate the traffic shaping and the number of signals to incorporate the shaping could be larger than one.

In one embodiment, FIG. 10 shows the traffic shaped from the West direction is through “m” signals that are placed at the distance of {w₁, w₂, . . . , wₘ}. The Fig. shows the vehicles reaching 1006, 1004, and 1002 before leading to the final signal 202 before entering the shared resource traffic junction. The Fig. also shows the traffic shaped from the North direction through “i” signals that are placed at the distance of {n₁, n₂, . . . , nᵢ}. The Fig. also shows the vehicles passing through 1016, 1014 and 1012 signals before reaching junction signal 204 to enter the shared resource traffic junction. The goal is to engineer the flow with an intelligent methodology that can streamline the traffic optimizing the throughput and capacity of the shared resource traffic junction. Similarly, the Fig. depicts the traffic originating from the East side where the vehicles pass through signals 1026, 1024 and 1022 before entering the shared resource traffic junction through signal 206. The “n” signals are optimally placed at distances between them as {e₁, e₂, . . . , eₙ}. “n” is used to describe the distances between the traffic signals of North direction (1016, 1014, and 1012) and in the same time the number of distances in the east direction (e₁, e₂, e₃, . . . , eₙ). The signal placement is predetermined based on the traffic volume and vehicle speed limits in the multilane junction and the behavior of the signal to streamline the traffic is adaptively determined using the proposed methodology. The Fig. also depicts the traffic originating from the South side where the vehicles pass through “j” traffic signals placed at distance of {s₁, s₂, . . . , sⱼ}. The vehicles pass through signals 1036, 1034, and 1032 before reaching the final signal 208 to enter the shared resource traffic junction.

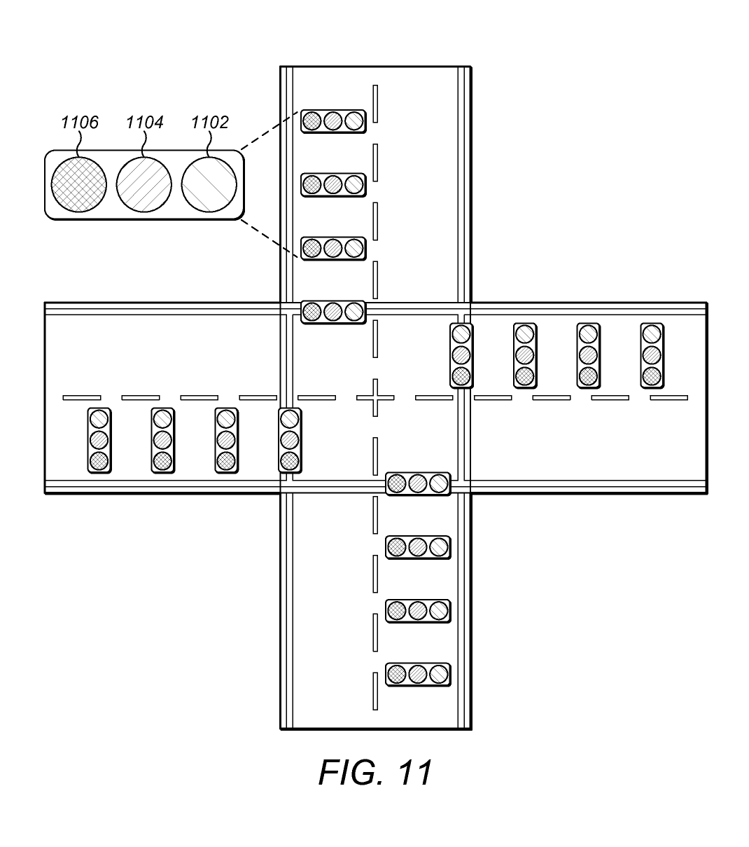

FIG. 11 illustrates an exploded view of the multistage binary traffic shaping system. In one embodiment, the Fig. shows a multistage discrete binary traffic shaping system. The traffic signals that are placed in regular intervals provide three lights namely Red 1106, Amber 1104 and Green 1102. Every traffic signal in West, North, East and South direction are set to the optimized on-off time interval for streamlining so that the traffic flow can be controlled far before the vehicles arrive close to the shared resource traffic junction enabling the junction access smooth and fast, and thus optimizing the throughput and capacity. In one embodiment, the proposed methodology encompasses a binary traffic shaping system as the signal lights are either on or off and does not provide a gradation. The duration of on-off is set based on the intelligent module so the vehicles can form a queue by stopping if Red at an intermediate traffic signal or move ahead without any hitch if Green.

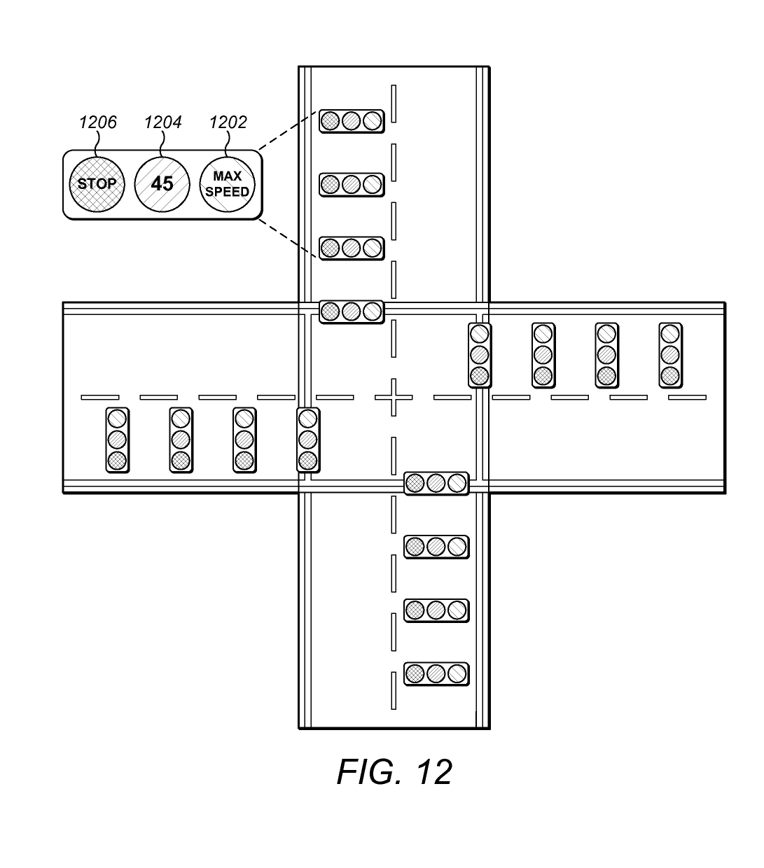

FIG. 12 illustrates the proposed multistage adaptive traffic shaping system. In the proposed system, multiple traffic signals are present with each traffic signal having Red 1206, Amber 1204 and Green 1202 lights. The Amber 1204 light will be able to adaptively indicate increase or decrease in the speed 1204 of the vehicles to intelligently adjust the traffic queue. This enables the adaptive traffic shaping to adjust the queue and ultimately achieve the smoothening of the traffic through the shared resource traffic junction. The speed limit 1204 and Max speed indicator 1202 is provided through the intelligent module in the back end that calculates based on traffic pattern in the other directions. In one embodiment, the traffic pattern in four different directions East, West, North and South are shown in Fig. The system can handle any number of lanes in various directions to adjust the speed to achieve the optimality in throughput and capacity of shared resource. In another embodiment, the binary adaptive traffic shaping system shown in FIG. 11 is a special case, where Amber 1204 simply indicates vehicles to slow down and being alert. In another embodiment, shown in FIGS. 6 and 7 are special cases of the number of traffic signals being two to make it an adaptive two stage system. In another embodiment, shown in FIGS. 4 and 5 is a special case with single traffic signal, namely adaptive single stage system. This compared with FIGS. 2 and 3 depicting the technology today clearly show how rudimentary the available system at present is.

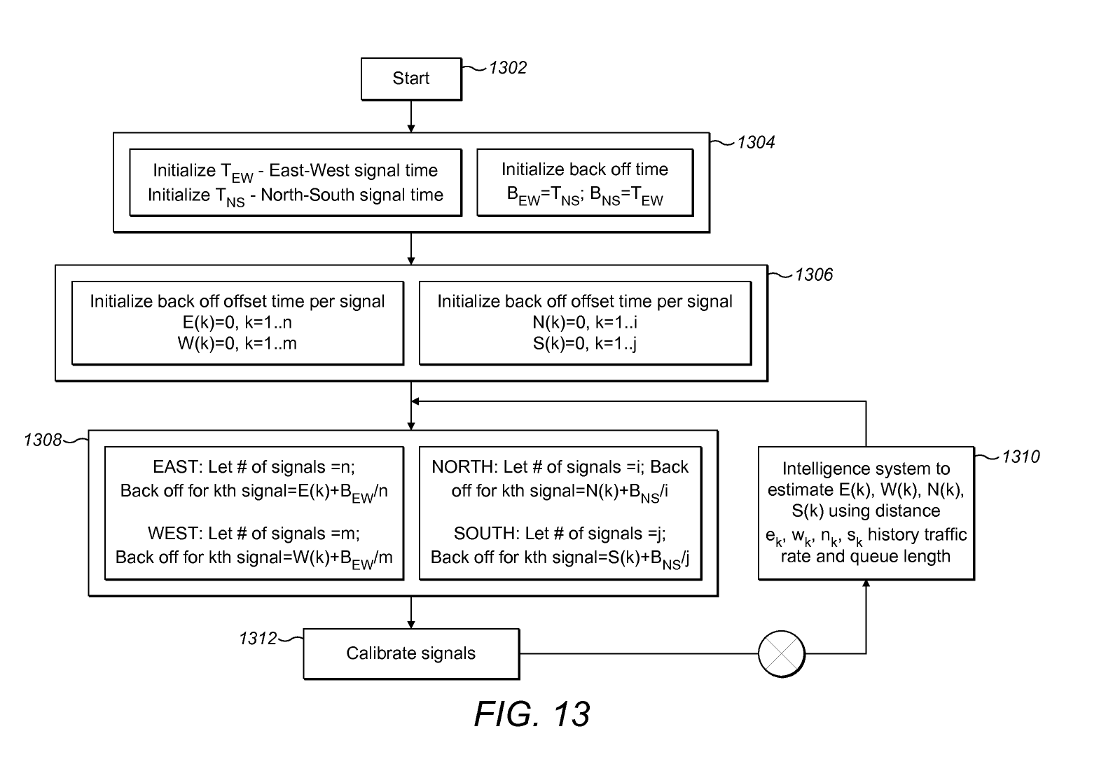

FIG. 13 illustrates the proposed intelligent traffic shaping methodology to analyze and determine the optimal value for the traffic signals to enable smooth and optimal transition through the shared resource traffic junction. The methodology is a control system that can run in the background as a standalone intelligent system. Initially the signal time is initialized. The back off time is initialized to the signal time 1304. Let E(k) for all k from 1..n be the total number of traffic signals in the East direction. Let W(k) for all k from 1..m be the total number of traffic signals in West direction. Let N(k) for all k from 1..1 be the total number of traffic signals in North direction. Let S(k) for all k from 1..j be the total number of traffic signals in the South direction. All E(K), W(k), N(k) and S(k) are initialized to zero 1306. Initial Back off time for every signal is calculated as the total back off time divided equally among all the signals. In one embodiment, the back off time for the kth signal in East will be E(k)+(total signal time/number of signals). Initially, the back off time will be equal to the main signal time divided equally among all the signals 1308. In another embodiment, the same is calculated for West, North and South direction. The generalized version can have any number of directions. The traffic signals in all direction are calibrated with the new value.

The control system 1310 will receive the traffic data, queue length, vehicle load and the utilization of the shared resource. The estimation of the queue length and traffic data is done by periodic measurement as the distance between the signals is known. In addition, hysteresis is used based on past data and analysis takes the past time of day and day of week information into account to intelligently and proactively estimate the traffic pattern. For example, the increase in queue length can be correlated to morning office time traffic and hence the intelligent system will be able to forecast a longer “Alert” time and lower speed in Amber to the approaching vehicles so they can reduce the speed and not congest the shared resource traffic junction. Similarly, intelligent system will use the data for lean afternoon period by forecasting a higher speed in Amber so the shared resource can be optimally used by an approaching vehicle as there is lower occupancy of the road ahead. The intelligent control system estimates E(k), W(k), N(k) and S(k) based on the periodic information from the traffic environment, which is fed into the system. The system 1308 uses the new values to calibrate the signals 1312 for the next cycle. As the control system continuously and periodically fine tunes the parameters, in steady state the performance of the system is optimal in steady state leading to smoother traffic pattern in shared resource traffic junction.

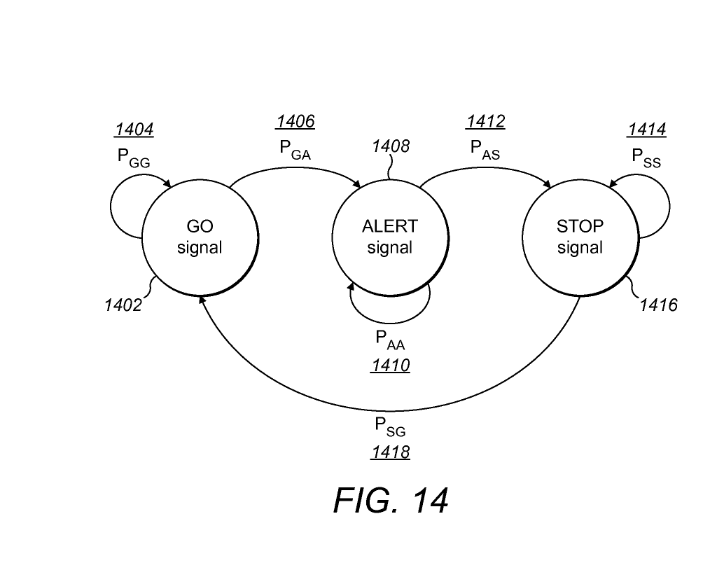

FIG. 14 illustrates the state transition diagram of the traffic signals for optimizing the performance. The system is always in one of the three signal states Green, Amber or Red. The approaching vehicle has a probability of P_{GG} to drive through the signal where P_{GG} is the probability that the signal stays in the Green state 1404. The system transits from Green to Alert with a probability of P_{GA} 1406. The vehicles need to be alert with a probability of P_{AA} 1410 and has to prepare to stop with a probability of P_{AS} 1412. The vehicles will stop with a probability of P_{SS} 1414, which is the probability of staying in the Red state. The vehicles prepare to move with a probability of P_{SG} 1418 as that is the probability of state transition to the Green state. The state transition matrix based on the state transition diagram helps in getting the initial probability of the signals being in a particular state depending on the time spent in that state initially. Intelligent control system can alter the system behavior to reach a steady state transition.

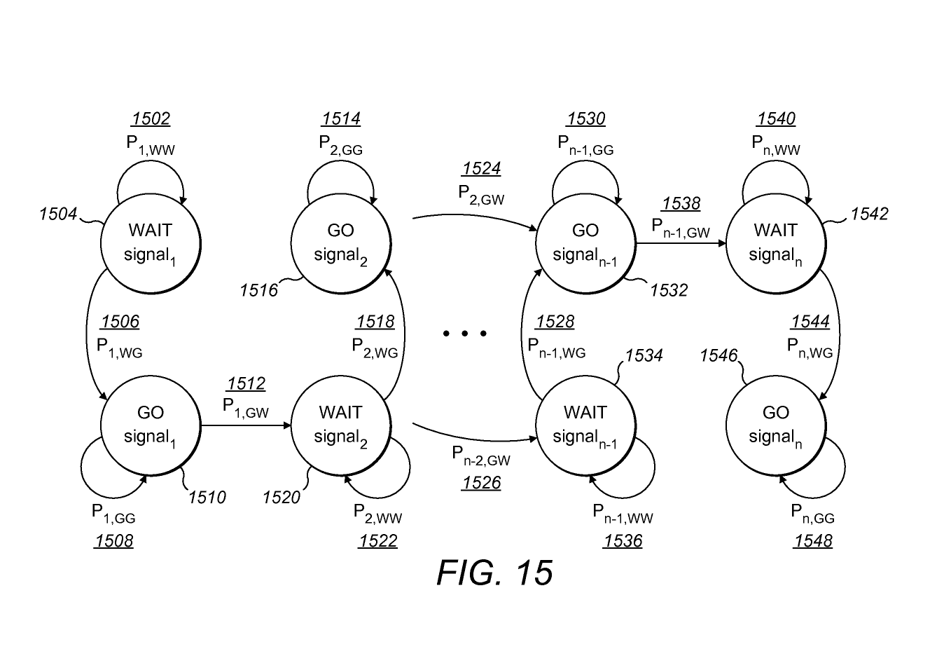

FIG. 15 illustrates the vehicle state transition diagram that is used to calculate the expected time taken by a vehicle to pass through all the signals and the shared resource traffic junction. The goal of the intelligent system is to minimize this time for smooth flow of vehicles through and optimizing the capacity. A vehicle in any direction, say goes through “n” traffic signals. The vehicle can be in any of the “2n” states, with each traffic light contributing to a Wait state and a Go state. The probability of the vehicle to be in Wait state in signal 1 is P_{1,WW} 1502 and probability of transiting to Go 1506 is P_{1,WG} and staying in Go 1510 is P_{1,GG}. The vehicle can transit from signal 1 to signal 2 with probability P_{1,GW}. Similarly, for any signal “k”, the probability of a signal to be in Go is P_{k,GG} 1514, 1530, 1548. The probability of the signal transiting to next state is P_{k,WG} 1518, 1528, 1544 and staying in Wait is P_{k,WW} 1522, 1536, 1540. The vehicle exits when the final signal has Green light. This Markov chain provides a clear state transition matrix that is used as initial condition which the intelligent system uses to calculate the adaptive waiting time in Amber for every signal. The control system uses the state transitions to calculate the optimal slow down or speed up the vehicle needs to do to traverse all the states quickly without congesting the shared resource traffic junction. The control system may reside in the processor, hard drive, traffic control boards, central traffic control system, mobile devices, built into car computers, driverless car controls, and cell phones. The control system may be a standalone, embedded and/or enterprise level application and/or software that requires a processor to implement it.

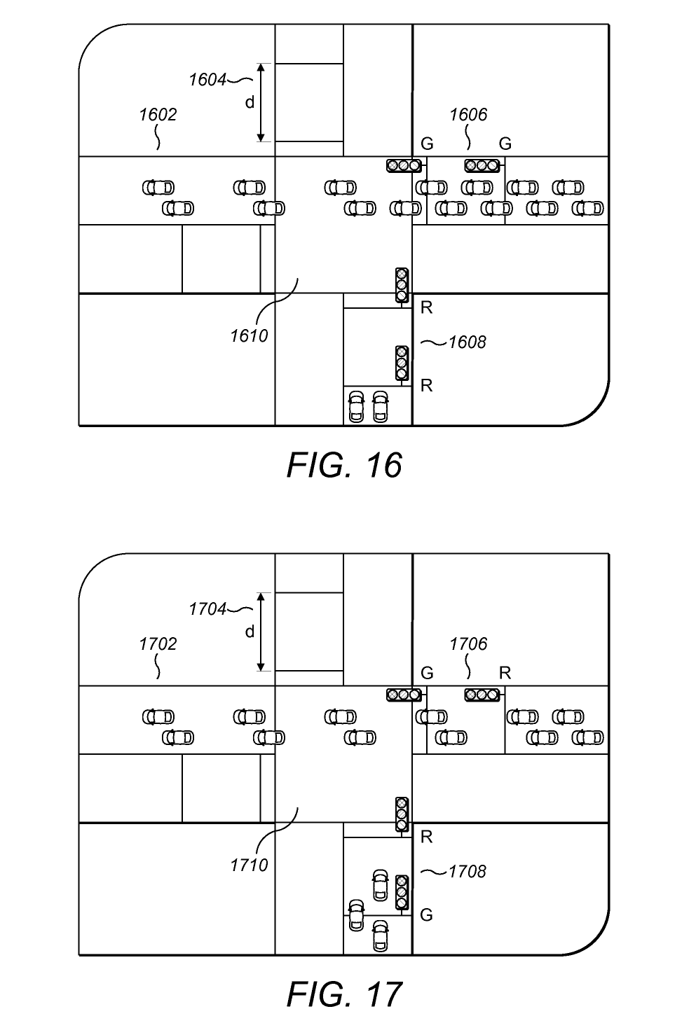

FIG. 16 illustrates an embodiment of general system. In the illustrated two stage system where there are two traffic lights for control synchronization in East 1606 and South 1608 direction. The two lights on the East direction are green; the vehicles on the East direction can cross the intersection 1602. The lights on the South direction are red making vehicles stop.

FIG. 17 continues the illustration of the embodiment of general system. The first lights on the East direction 1706 turn red based on the intelligent control system input, the second lights still green, it allows all the vehicles between the two lights to reach the intersection before the second lights turn red. In the same time, on the South direction the first lights turn green 1708, the cars start to move, the second lights still red. This allows the proper utilization of the lanes and the buffer in East direction is emptied.

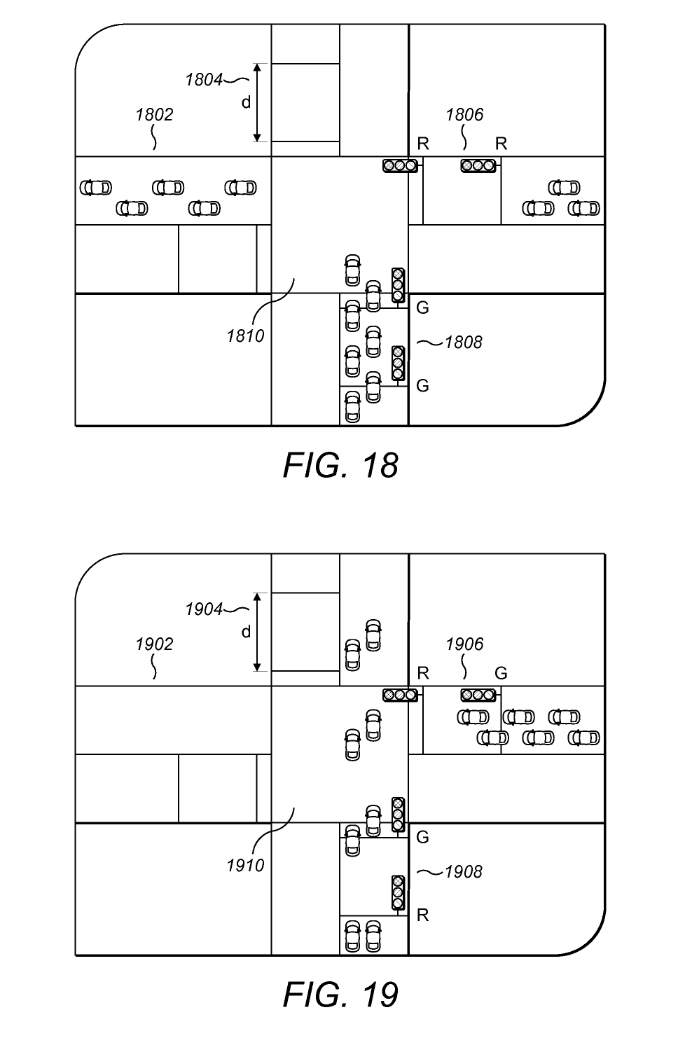

FIG. 18 continues the illustration of the embodiment of the general system. The second lights on the East direction turn red 1806; it stops all the vehicles that could not reach the second lights when it was green (vehicles that had problems between the two lights). The second lights in the south direction turn green 1808, which allow all the cars of this direction to pass without stopping at the second lights. This allows proper utilization of the shared resource traffic junction 1810.

FIG. 19 continues the illustration of the embodiment of the general system. The first lights on the East direction turn green 1906 based on the control system input; vehicles that are waiting can start to move. In the same time, the first lights in the south direction turn red 1908; this stops the vehicles. The second lights of the south direction still green 1908; it allows the vehicles between the two signals to cross the intersection 1910.

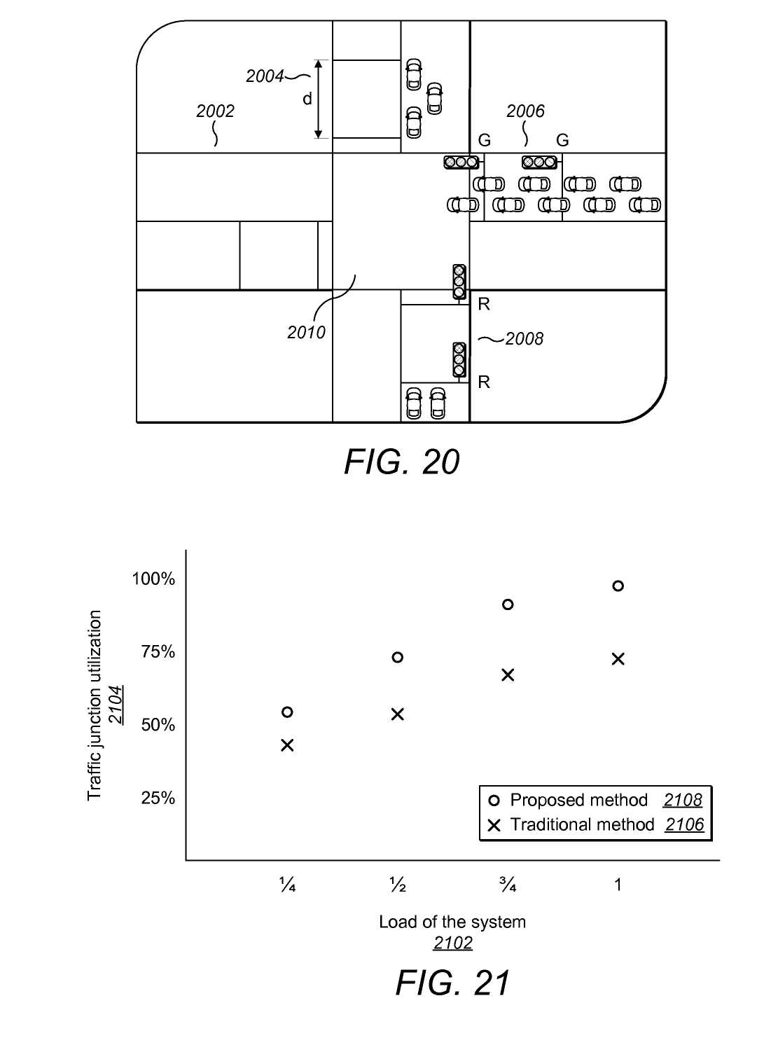

FIG. 20 continues the illustration of the embodiment of the general system. The second lights on the south direction turn red 2008; it stops all the vehicles on this direction. The second lights on the East direction turn green 2006; the vehicles on this direction will cross the intersection without stopping at the second lights. This completes the cycle we started from FIG. 16 completing one periodic cycle of the control system optimizing the shared resource traffic junction 2010.

FIG. 21 illustrates the performance characteristic of the traffic junction utilization 2104. When the system load 2102 in multilane increases, the graph shows the utilization of the traffic junction increases. After certain point the utilization flattens. In the traditional method that is in vogue today 2106, we notice that the utilization is lower even when the load is high. This is due to the fact that the vehicles move from Red, i.e., waiting state to Green. It takes some time for them to start, change gear and move during which the shared resource is not used. When compared to the proposed method 2108, the graph shows higher utilization as the load increases. When the adaptive intelligent system sets alert speed at multiple signals, the traffic is fluid so that it can access the shared resource immediately after another lane relinquishes the resource. This leads to higher utilization, lower waiting time, lower pollution and lower gas expense.

In addition, it will be appreciated that the various operations, processes, apparatuses and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
gathering a periodic traffic information from a traffic signal and a traffic junction in both direction simultaneously; and
calculating using hysteresis methods a queue length, a present time interval and compile data to determine a speed of a vehicle to adhere to a rule a smooth traffic flow through the traffic light and the traffic junction.

2. The method of claim 1, further comprising:
communicating with the traffic signal for timing in both direction; and
computing and refining the speed of the vehicle in a rational speed to minimize waiting and maximizing traffic junction.

3. The method of claim 2, further comprising:
communicating with a Control system to communicate with a vehicle, adjust and calibrate signal timings in various directions and on a device in the vehicle; and
synchronizing traffic pattern to match the flow between the traffic and traffic junction.

4. The method of claim 3, further comprising:
analyzing, computing and redefining a time interval between Red, Amber and Green states for traffic signal.

5. The method of claim 1, further comprising:
implementing a single lane, two lane and multilane control in traffic junction.

6. A method, comprising:
controlling data collection using a binary control system to gather, analyze and compute the time for signals to stay in Amber or Green to achieve smooth traffic flow to reduce wait time.

7. The method of claim 6, further comprising:
implementing staged implementation of the Amber and green light for several traffic junction at a time in anticipation of vehicle traffic flow.

8. The method of claim 7, further comprising:
queuing the vehicle using multiple warning lights and displaying the speed at which they need to travel at a particular sector of the road for smooth transition through a traffic junction.

9. The method of claim 6, further comprising:
displaying a traffic speed using the Amber light to control the vehicle speed so
that the vehicle does not need to stop at the traffic junction.

10. The method of claim 6, wherein the binary control system uses Markov chain to provide a clear state transition matrix to slow down a vehicle or to increase the speed of a vehicle to go through the traffic junction.
